(19) United States
(12) Patent Application Publication
(10) Pub. No.: US 2022/0300256 A1
(43) Pub. Date: Sep. 22, 2022

(54) Validating Binary Image Content

(71) Applicant: Wind River Systems, Inc., Alameda, CA (US)

(72) Inventors: Arlen BAKER, Alameda, CA (US); Matt JONES, Portland, OR (US)

(21) Appl. No.: 17/301,015

(22) Filed: Mar. 22, 2021

(51) Int. Cl. G06F 8/10; G06F 8/71; G06F 11/32

(52) U.S. Cl. CPC G06F 8/10; G06F 8/71; G06F 11/327

(57) ABSTRACT

A binary image of a computer program can be verified as accurate. The verification includes receiving one or more requirements corresponding to source code changes for a program to be loaded on a processing device, generating a representation of the program including the source code changes, determining a change in the representation based on a comparison of the representation with one or more previously stored representations of the program and determining whether the change in the representation corresponds to the one or more requirements.

### BACKGROUND INFORMATION

Source code may represent the fundamental component of a program, an application, etc. The source code may be compiled to generate object code that may be used to execute the program on a processor. A build server may create a binary image representative of the source code. In some cases, the build server may be attacked to compromise the binary image creation process where malware or other malicious software is inserted in the generated binary image. Thus, when any required change to the source code is made (e.g., a bug fix, a patch, etc.), the attack on the built server can cause a change to a component of the binary image unrelated to the required change. It is possible that the change in the unrelated component may go undetected since it is expected that the binary image will change due to the required source code change.

### SUMMARY

Some exemplary embodiments are related to a method including receiving one or more requirements corresponding to source code changes for a program to be loaded on a processing device, generating a representation of the program including the source code changes, determining a change in the representation based on a comparison of the representation with one or more previously stored representations of the program and determining whether the change in the representation corresponds to the one or more requirements.

Other exemplary embodiments are related to a system having a requirements server configured to receive one or more requirements corresponding to source code changes for a program to be loaded on a processing device. The system also includes a build server configured to receive an updated source code based on the source code changes corresponding to the one or more requirements and to generate a representation of the program including the source code changes. The system further includes an image comparison server configured to determine a change in the representation based on a comparison of the representation with one or more previously stored representations and to determine whether the change in the representation corresponds to the one or more requirements.

Still further exemplary embodiments are related to a comparison server configured to perform operations. The operations include receiving one or more requirements corresponding to source code changes for a program to be loaded on a processing device, receiving a representation of the program including the source code changes, determining a change in the representation based on a comparison of the representation with one or more previously stored representations of the program and determining whether the change in the representation corresponds to the one or more requirements.

### BRIEF DESCRIPTION OF THE DRAWINGS

FIG. 1 shows an exemplary system used to determine a validity of binary image content according to the exemplary embodiments.

FIG. 2 shows an exemplary method for determining a validity of binary image content according to the exemplary embodiments.

### DETAILED DESCRIPTION

The exemplary embodiments may be further understood with reference to the following description and the related appended drawings, wherein like elements are provided with the same reference numerals. The exemplary embodiments are related to a device, a system, and a method for determining a validity of binary image content and an image comparison server that determines the validity of binary image content. The exemplary embodiments may compare a newly generated binary image with one or more previously stored binary images to determine if changes in the newly generated binary image from the previous binary image is expected based on a required change to the source code.

The exemplary embodiments are described with regard to generating a binary image of source code and validating the contents of the binary image. Those skilled in the art will understand that a binary image is a computer file including the contents and structure of a disk volume or a data storage device. The binary image replicates the structure and contents of a storage device independent of the file system. However, the particular components and inputs/outputs described with respect to the exemplary embodiments are only illustrative and variations to the components, inputs, and/or outputs may be used within the scope of the exemplary embodiments. For example, the binary image may represent any representation used for another object. In a further example, the exemplary embodiments relate to a build environment for a program but may also be applied to other environments in which source material and a component processing the source material are authenticated.

A build server may be used to compile and assemble a binary image of source code corresponding to a computing program. With the build server being the first component to receive the source code and generate the binary image, a malicious source may compromise the build server so that malware and/or other malicious software is inserted in any binary image generated by the build server. If a build system (e.g., the build server) is hacked to include malware in the binary image at a time when a change in the binary image is expected (e.g., when the source code has changed due to some requirement), the improper binary image may be passed on to subsequent processing components.

The exemplary embodiments provide a mechanism to compare a newly generated binary image with one or more previously stored binary images to determine whether the newly generated binary image is valid. The mechanism according to the exemplary embodiments may utilize one or more required changes to the source code to determine if the change from the previous binary image to the newly generated binary image is valid.

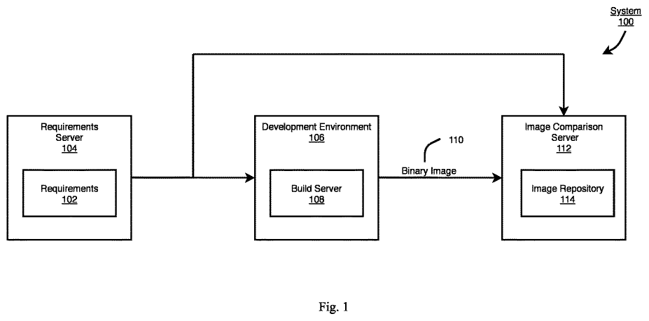

FIG. 1 shows an exemplary system 100 used to determine the validity of a binary image according to the exemplary embodiments. The system 100 may represent a build environment in which binary images are generated. The binary image may be used by a processing component to verify that a program being executed is clean without malicious or inadvertent coding. For example, the processing component may be included in any electronic device. The system 100 may include a requirements server 104, a development environment 106 including a build server 108, an image comparison server 112, and an image repository 114.

The exemplary embodiments are described with regard to a system 100 including servers as separate components that individually perform respective operations with inputs and outputs being exchanged between one another (e.g., via direct communication pathways, via a wired and/or wireless network, etc.). However, this configuration of separate servers having a communication functionality is only exemplary. According to other exemplary embodiments, one or more of the functions described as being performed by the servers of the system 100 may be represented in a single processing device or a single function may be distributed to multiple processors in one or more devices. The servers of the system 100 may therefore represent the operations that are performed within the device. The servers may also represent modular components that provide further functionalities when incorporated with a main processing device (e.g., the build server 108 may be implemented as the main processing device with the image comparison server 112 and the image repository 114 being modular components that interact with the build server 108). In further exemplary embodiments, the system 100 may be represented in a cloud or with virtual machines. When implemented in a cloud or with virtual machines, the functionalities described for the servers 104, 108, 112 of the system 100 may be instructions that may cause other components or other devices to perform corresponding operations.

The requirements 102 may include any changes that are to be made to the source code of a program. The source code may be a fundamental component from which a computer program is created. For example, the source code may be computer code (e.g., using any programming language, script language, etc.) that is compiled (e.g., to generate object code) to create an executable program. The requirements 102 may include patches, security updates, other updates, etc. Change in a specific part of the source code will effectuate a change in a corresponding component or section of the binary image. The requirements 102 may be periodic changes or triggered changes that are triggered by the software manufacturer or any other predefined triggering mechanism. These requirements may be delivered to and stored by the requirements server 104. The use of a server to store the requirements 102 is only exemplary as the requirements 102 may be stored in any known manner that may be separate from the requirements server 104.

The development environment 106 may include any number of processing devices that are used to alter the computer program. For example, based on the requirements 102, one or more programmers may generate updated source code 106 to implement the requirements. This updated source code may then be further processed within the development environment 106, e.g., compiled, linked, etc. In the example of system 100, the build server 108 may be considered to be the processing component that performs this further processing. However, as described above, the functions described as being performed by the build server 108 may be distributed to multiple processing devices within the development environment 106.

In the exemplary embodiments of FIG. 1, the build server 108 may be configured to receive the updated source code, compile the updated source code into object code, link the object code to generate executable code and generate a binary image 110 of the updated program. The build server 108 may use a clean slate approach with no unapproved configurations or artifacts present in performing its operations. The build server 108 operates with the updated source code being generated from the requirements 102 stored in the requirements server 104 and based on an assumption that the updated source code is committed code to be included in a release version of the program. In performing the operations, the build server 108 may mimic an environment of the destination processing component to emphasize areas where a developer's local configurations may make the source code to behave in an inadvertent or different manner. For example, the program may be configured to run on any type of electronic device (e.g., a mobile phone, a tablet computer, a smartphone, a phablet, an embedded device, a wearable device, a Cat-M device, a Cat-M1 device, an MTC device, an eMTC device, another type of Internet of Things (IoT) device, a set top box, a smart television, a desktop computer, a desktop computer, etc.) and the build server 108 and development environment 106 may mimic the desired environment.

The binary image 110 may be delivered to an image comparison server 112 along with the requirements 102. In some exemplary embodiments, the image comparison server 112 is configured to break down the binary image 110 into its respective components (or sections) and compare those components to their counterparts in a previous binary image stored on an image repository 114. Again, in the exemplary embodiment of FIG. 1, the image repository 114 is shown as being part of the comparison server 112. However, this is only exemplary and the image repository 114 may store previous binary images of the program in any known manner that may be separate from the requirements server 104.

The comparison of the component(s) of the previous binary image to the current binary image 110 will show which component(s) have changed between the two binary images. The comparison server 112 may then compare the component(s) that have changed to the requirements 102. If the change(s) are the expected results of changes made to the source code based on the requirements 102, then the image comparison server 112 determines that the binary image 110 is valid. If, however, a change to a component (or components) is found which is inconsistent with the requirements 102, then an alert may be generated by the image comparison server 112. For example, if the requirements 102 dictate that a patch or bug fix is necessary for openSSL, but a comparison of the binary image 110 and a previous binary image shows a change in another component or section other than openSSL, then an alert is generated to indicate a potentially malicious modification of that component.

In some embodiments, the change in the binary image 110 may automatically trigger the prevention of the release of the change if such a misalignment between the binary image 110 and the previous binary image is found. In some embodiments, a list of changes found in the binary image 110 with no corresponding requirements may alternatively or additionally be output based on the comparison.

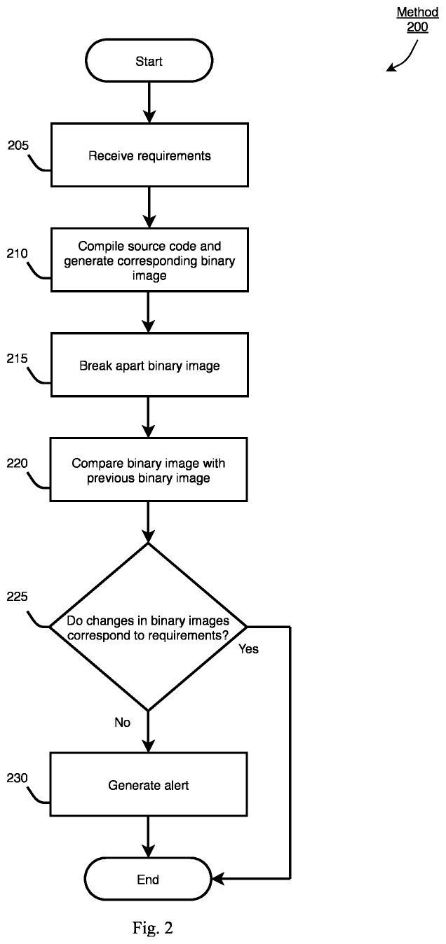

FIG. 2 shows an exemplary method for determining a validity of binary image content according to the exemplary embodiments. The method 200 may relate to the operations performed by the system 100 in breaking down a newly generated binary image 110 and comparing its components with their counterparts in a previously stored binary image to determine if the changes to the newly generated binary image 110 correspond to required changes to the source code. The method 200 will be described with regard to the system 100 of FIG. 1.

In 205, the requirements server 104 receives the one or more requirements 102. The source code is then changed/updated to satisfy the requirements 102 via the development environment 106. Upon receiving the updated source code, the build server 108, in 210, compiles and links the updated source code and generates the binary image 110. For example, the build server 108 may compile the updated source code 106, link (or assemble) the compiled code and generate the binary image 110.

In 215, the image comparison server 112 breaks apart the binary image 110. In some embodiments, for example, the binary image 110 may be in an executable and linkable format (ELF) which the image comparison server 112 breaks apart into the components/sections that make up the binary image 110. In 220, the image comparison server 112 compares the components of the binary image 110 with their counterparts in a previously stored binary image (or images) from the image repository 114.

In 225, the image comparison server 112 determines whether the changes between the component(s) of the binary image 110 and their counterparts in the previously stored binary image correspond to the requirements 102. That is, the image comparison server 112 determines whether this change is expected based on the requirements 102. If the changes in the binary image 110 are expected based on the requirements 102, the image comparison server 112 does not flag the change or stop its release. If one or more changes in the binary image 110 do not correspond to the requirements 102, the image comparison server 112 continues to 230 where an alert is generated. Alternatively, or in addition, the image comparison server 112 may attempt to address unexpected change in the binary image 110 and stop the release of the change.

The exemplary embodiments provide a device, system, and method for verifying whether changes in a binary image correspond to required changes in the source code. With possible attacks on a build server that generates a binary image, the mechanism according to the exemplary embodiments provides a verification process to ensure that changes to the binary image are the result of required changes to the source code.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows platform, a Mac platform and MAC OS, a mobile device having an operating system such as iOS, Android, etc. In a further example, the exemplary embodiments of the above described method may be embodied as a program containing lines of code stored on a non-transitory computer readable storage medium that may be executed on a processor or microprocessor.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method, comprising:
receiving one or more requirements corresponding to source code changes for a program to be loaded on a processing device;
generating a representation of the program including the source code changes;
determining a change in the representation based on a comparison of the representation with one or more previously stored representations of the program; and
determining whether the change in the representation corresponds to the one or more requirements.

2. The method of claim 1, wherein the representation is a binary image.

3. The method of claim 1, further comprising:
breaking down the representation into constituent components,
wherein the change is determined based on a comparison of the constituent components with corresponding constituent components of the one or more previously stored representations.

4. The method of claim 1, wherein, when the change in the representation does not correspond to the one or more requirements, the method further comprises:
generating an alert.

5. The method of claim 4, further comprising:
generating a list of changes with no corresponding requirement.

6. The method of claim 4, further comprising:
preventing the change from being released.

7. A system, comprising:
a requirements server configured to receive one or more requirements corresponding to source code changes for a program to be loaded on a processing device;
a build server configured to receive an updated source code based on the source code changes corresponding to the one or more requirements and to generate a representation of the program including the source code changes; and
an image comparison server configured to determine a change in the representation based on a comparison of the representation with one or more previously stored representations and to determine whether the change in the representation corresponds to the one or more requirements.

8. The system of claim 7, wherein the representation is a binary image.

9. The system of claim 7, wherein the image comparison server is further configured to:
break down the representation into constituent components,
wherein the change is determined based on a comparison of the constituent components with corresponding constituent components of the one or more previously stored representations.

10. The system of claim 7, wherein, when the change in the representation does not correspond to the one or more requirements, the image comparison server is further configured to:
generate an alert.

11. The system of claim 10, wherein the image comparison server is further configured to:
generate a list of changes with no corresponding requirement.

12. The system of claim 10, wherein the image comparison server is further configured to:
prevent the change from being released.

13. A comparison server configured to perform operations comprising:
receiving one or more requirements corresponding to source code changes for a program to be loaded on a processing device;
receiving a representation of the program including the source code changes;
determining a change in the representation based on a comparison of the representation with one or more previously stored representations of the program; and
determining whether the change in the representation corresponds to the one or more requirements.

14. The comparison server of claim 13, wherein the representation is a binary image.

15. The comparison server of claim 13, wherein the operations further comprise:
breaking down the representation into constituent components,
wherein the change is determined based on a comparison of the constituent components with corresponding constituent components of the one or more previously stored representations.

16. The comparison server of claim 13, wherein, when the change in the representation does not correspond to the one or more requirements, the operations further comprise:
generating an alert.

17. The comparison server of claim 16, wherein the operations further comprise:
generating a list of changes with no corresponding requirement.

18. The comparison server of claim 16, wherein the operations further comprise:
preventing the change from being released.
